(19) United States
(12) Patent Application Publication
(10) Pub. No.: US 2002/0190525 A1
(43) Pub. Date: Dec. 19, 2002

(54) Inverter controlled, parallel connected asynchronous generator for distributed generation

(75) Inventors: James Worden, North Andover, MA (US); Lance P. Haines, Wilmington, MA (US); Beat J. Arnet, Cambridge, MA (US)

Correspondence Address: Norman P. Soloway, Hayes, Soloway, Hennessy,, Grossman & Hage, 175 Canal Street, Manchester, NH, 03101, US

(73) Assignee: Solectria Corporation

(21) Appl. No.: 09/883,700

(22) Filed: Jun. 18, 2001

(51) Int. Cl. H02P 9/00

(52) U.S. Cl. 290/1 A

(57) ABSTRACT

A distributed generation system is disclosed that is capable of conditioning power from a utility grid, providing backup power in the event the utility grid fails, and exporting excess power to the utility grid. The system comprises an engine coupled to an asynchronous generator, an energy storage device, an engine controller capable of managing the engine and controlling its torque or speed or power, and an inverter for generating an AC output and also capable of controlling the frequency and voltage of the generator to match the frequency of a coupled utility grid.

### BACKGROUND OF THE INVENTION

The present invention relates generally to systems for providing uninterrupted power, and more particularly to a distributed generation system that can condition power from the grid, provide backup power in the event the grid fails, and export excess power to the grid.

### FIELD OF THE INVENTION

Engine-generators and battery-backed electronic inverters are used in different ways to provide backup power, condition power from the utility grid, and to produce power for export to the grid. Either alone has shortcomings: battery-backed inverters alone have limited energy storage and thus short durations when power fails. Synchronous-machine electrical generators need to be synchronized mechanically to the grid frequency and require controllable excitation for non-end connected applications: asynchronous machine generators need not be accurately speed controlled to deliver power to a grid, but they require means of excitation (capacity bank, battery and inverter) and mechanical slip control for non-grid connected operation. Consequently, inverters and generators are often combined together, to complement each other.

Electronic inverters, when backed by a battery, are often used in facilities as uninterruptible supplies of alternating current. Typically they condition the voltage of utility electrical power, and provide backup power for short durations in case of utility grid power brownouts and failures. In other words, when the grid voltage drops, the inverter provides current to bolster the line voltage. When the grid power fails, a transfer switch disconnects the grid, and the inverter alone powers the facility loads. For continuous operation over long periods of time, however, electric generators powered by external engines are required.

FIG. 1 depicts a three-phase power system 100 where a distributed generation (DG) system 102 is used to assist or substitute for the utility grid 104. The output of the DG system 102 is connected to the loads 106 in parallel to the utility grid 104. The DG system 102 may be isolated from the loads by means of an isolation transformer 108. The utility grid 104 may also be decoupled and stepped down by an isolation transformer 110. If the DG system 102 is capable of operating and sustaining the load 106 in case the utility grid 104 fails, a transfer switch 112 is required to disconnect the utility grid 104 from the load 106.

A prior art distributed generation system 200, as shown in FIG. 2, may comprise an engine 202, generator 204, rectifier 206, and a battery-backed inverter 210 combined in series. The AC power generated by the generator 204 must go through a two-step conversion. AC output from the engine driven generator 204 is rectified in a rectifier 206 to make direct current (DC), that keeps the battery 208 charged and powers an inverter 210 that makes AC output power at grid frequency, to supply loads and to export power to the grid. The AC power may be filtered by a filter 212. The AC output of the DG system 200 may be coupled to the isolation transformer 108 shown in FIG. 1. The AC output can be used for (i) conditioning power from the grid, (ii) providing backup power in the event the grid fails, and (iii) exporting excess power to the grid. The disadvantage of this design is that there are two power conversions, each resulting in loss and heating. Losses may be decreased through use of a delta-conversion architecture that is similar, but provides a bypass path for grid power that is acceptable.

A prior art distributed power generation system 300, as shown in FIG. 3, may comprise an engine 302, a synchronous-machine generator 304, and a battery-backed inverter 306 operated with their outputs in parallel but switched, to make a power conditioner or backup supply. The AC output of the DG system 300 may be coupled to the isolation transformer 108 shown in FIG. 1.

When grid power is available, the generator 304 is switched offline via a transfer switch 310 and the engine 302 is typically off. The inverter 306 monitors and conditions the utility power to the loads. When the inverter 306 senses that the grid power has failed, it signals the engine controller 314 to start the engine 302. The engine 302 start up period may exceed a minute. During this transition period, the inverter 306 provides all the power to the load from the battery 308. Once the generator 304 is powered up and at the right synchronous speed, its output is switched in by the transfer switch 310, in place of the grid, to power the load 106. The inverter 306 then eases off on its output, and conditions the generator output voltage. An engine controller 314 electrically coupled to the engine 302 and the inverter 306 is responsible for regulating engine speed, and thus determining line frequency. The inverter 306 synchronizes to the generator 304 output, but it does not control or correct variations in the generator output frequency. Therefore, such a DG system 300 cannot typically meet utility frequency specifications to provide utility grid-connected output.

When grid power is restored, the engine generator typically shuts off, and the inverter 306 powers the load 106 during a second transition phase, during which the inverter 306 output voltage and the phase is synchronized to that of the utility grid 104, and the main transfer switch 112 switches the grid power back into the load 106. The inverter 306 then can ease off its power output and finally take power in to recharge its battery 308. Thus, the system 300 can provide power and power conditioning. The shortcoming of the system 300 of FIG. 3, as mentioned above, is that it cannot typically export engine-generated power to the utility grid 104 because the synchronous-machine generator output frequency is difficult to synchronize to the grid frequency.

To summarize prior art for providing an uninterruptible power supply, the choices are a costly, inefficient two-step AC-DC-AC conversion process that can be used to condition power from the grid, provide backup power in the event of a utility grid failure, and export excess power to the grid or a more efficient system that can condition power from the grid and provide backup power in the event of a utility grid failure, but which is incapable of exporting power to the utility grid.

### BACKGROUND OF THE INVENTION

The present invention is directed to a novel generation system. It is an object of the present invention to provide a distributed power generation system that overcomes the deficiencies of the prior art. It is an object of the present invention to provide a more efficient distributed power generation system that can (i) condition power from the grid, (ii) provide backup power in the event the utility grid fails, and (iii) export excess power to the grid.

The above, and other objects, features and advantages of the present invention will be apparent in the following detailed description thereof, when read in conjunction with the appended drawings, wherein the same reference numerals denote the same or similar parts throughout the several views.

### BRIEF DESCRIPTION OF THE DRAWINGS

FIG. 1 is a block diagram showing the coupling of a distributed generation system to a utility grid to provide uninterrupted power to a load.

FIG. 2 is a block diagram of a first prior art distributed generation system useful in FIG. 1.

FIG. 3 is a block diagram of a second prior art distributed generation system useful in FIG. 1.

FIG. 4 is a block diagram of a first distributed generation system consistent with the present invention.

FIG. 5 is a block diagram of a second distributed generation system consistent with the present invention.

### DETAILED DESCRIPTION OF THE INVENTION

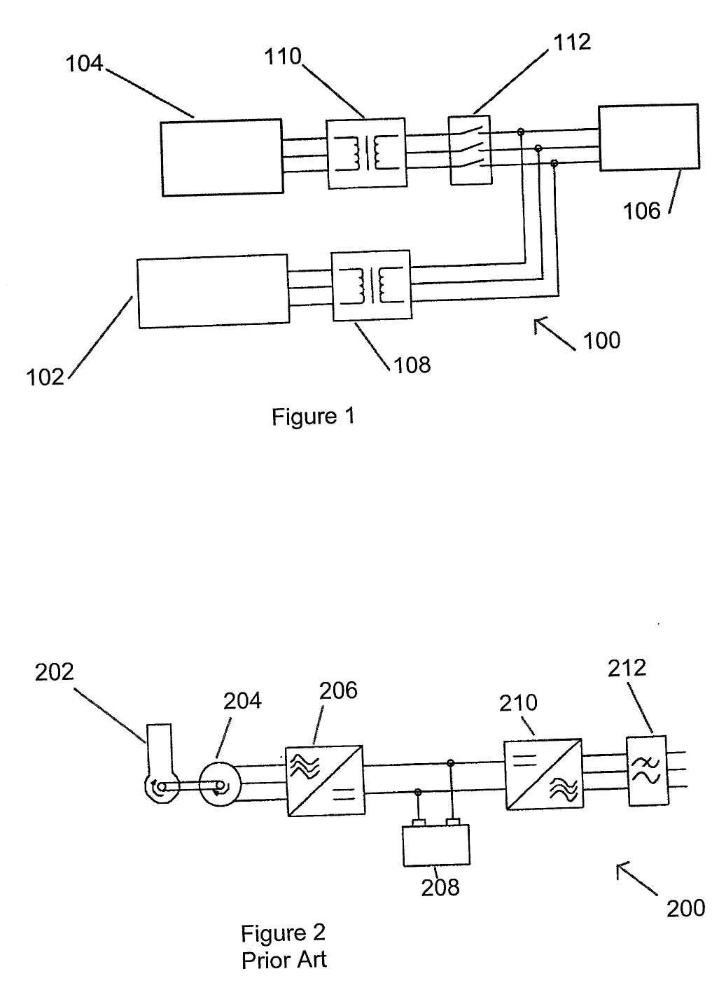

FIG. 4 is a block diagram of a first distributed generation (DG) system 400 that is capable of generating three-phase power. Distributed generation means a system divided up among two or more components. The output of the DG system 400 is preferably connected in parallel to a utility grid to power a load 106 as shown in FIG. 1. The system 400 comprises an engine 402 coupled to an asynchronous generator 404, an inverter 406 coupled to an energy storage device 408 such as a battery or ultracapacitor, an engine controller 414, and an optional filter 412. The generator 404 is capable of generating a three-phase AC output. The generator AC output may be connected in parallel to the three-phase AC output of the filter 412. The system is capable of conditioning power from the grid, providing backup power in the event the grid fails, and exporting excess power to the grid. Grid failure may be a complete lack of power (blackout) or insufficient power (brownout). The present invention tightly integrates the energy storage device-backed inverter and an engine-generator, in novel manners. The engine controller 414 may be coupled between the inverter and the engine, and is capable of controlling speed or torque or power level of the engine 402.

The DG system 400 may optionally comprise an inverter controller 416 capable of monitoring the load, and the utility grid in order to perform peak-shaving, net-metering, and time-of-use metering.

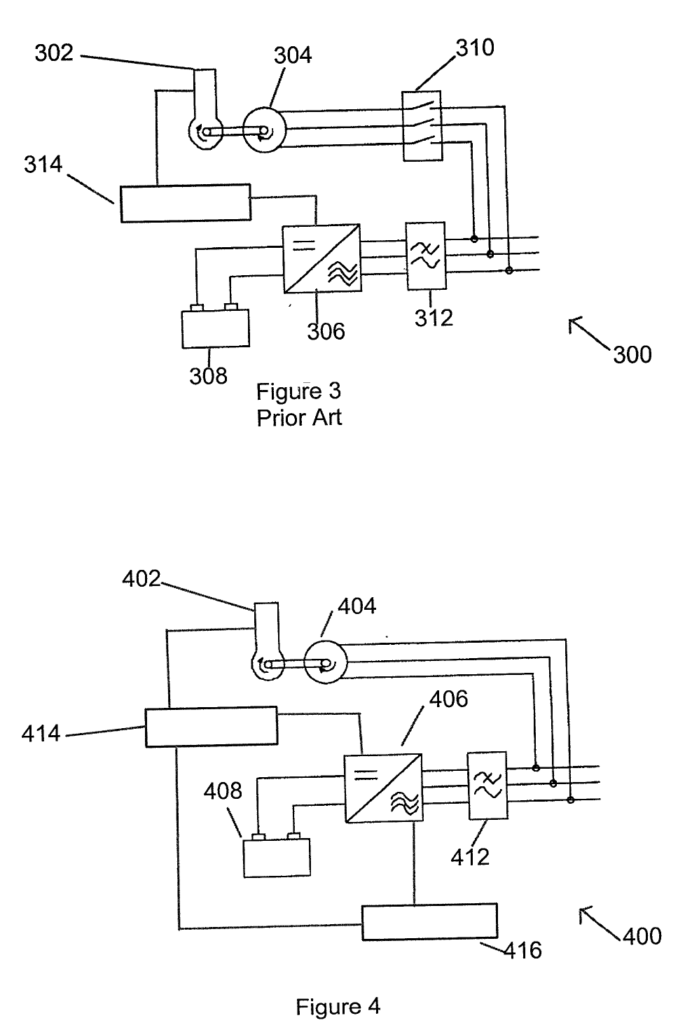

The system of FIG. 4 is different from that of FIG. 3 in structure and function. The inverter 406 controls the generator 404 output frequency and voltage, which allows connection of the DG system 400 to the grid and export power to it. Since the frequency of the generator 404 can be matched to the grid frequency by the inverter 406, there is no need for a transfer switch to disconnect the generator 404 when the DG system 400 is connected to the grid. A transfer switch can be very expensive to purchase and install and may be a source of maintenance issues. Another advantage of the present invention, is that since the engine 402 and generator 404 do not need to be electrically disconnected from the grid, they can run permanently and take over the load very rapidly, should the grid fail. As a consequence, and in contrast to the prior art shown in FIG. 3, a smaller battery is needed for load-leveling. It is, therefore, also conceivable to replace the battery with a bank of ultracapacitors; the advantage of ultracapacitors being that they are maintenance free, have a long life cycle, and do not require a sophisticated state of charge management. An ultracapacitor, or “supercapacitor,” stores energy electrostatically by polarizing the electrolytic solution. Though it is an electrochemical device (also known as an electrochemical double-layer capacitor), there are no chemical reactions involved in its energy storage mechanism. This mechanism is highly reversible, allowing the ultracapacitor to be charged and discharged hundreds of thousands of times. An ultracapacitor may be viewed as two non-reactive porous plates suspended within an electrolyte, with a voltage applied across the plates. The applied potential on the positive plate attracts the negative ions in the electrolyte, while the potential on the negative plate attracts the positive ions. This effectively creates two layers of capacitive storage, one where the charges are separated at the positive plate, and another at the negative plate. Ultracapacitors are available from Maxwell Technologies, Inc.

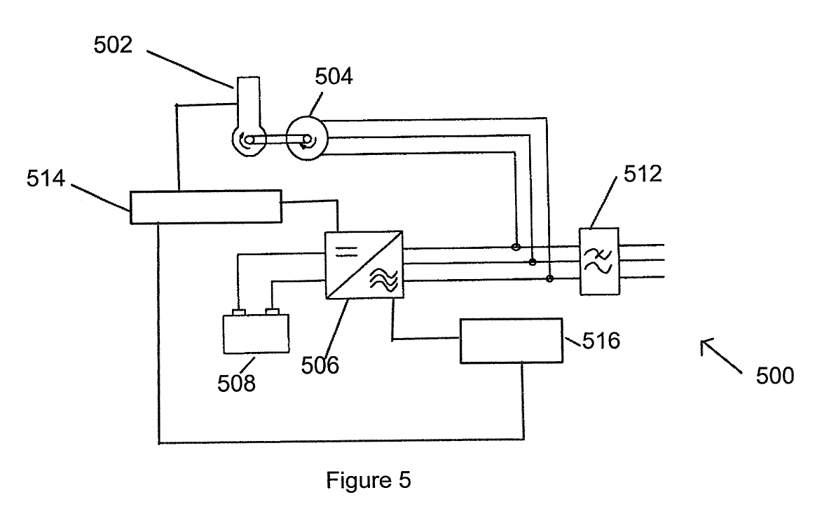

The inverter 406 is preferably a PWM—switched design, which may require an output filter 412 to smooth its voltage. The output filter 412 also provides impedance to allow phase adjustment to achieve required power factor when exporting power to the grid. A filter 512 alternatively may be placed at the output of the DG system, as shown in FIG. 5. When the grid is powering the loads, the generator 404 may need to free-spin synchronously in order not to load the system. A clutch between the engine and generator may then be necessary to keep the engine from having to turn. The generator windings may be in wye or delta configuration, or could be switched from wye for starting to delta for running. Details of the generator winding is disclosed in copending U.S. patent application Ser. No. 09/772,820 entitled “Electromechanically Controlled Changeover Switch” and is incorporated herein by reference in its entirety.

The present invention can condition power from the grid, provide backup power in the event the grid power fails, and export excess power to the grid without the costly, inefficient AC-DC-AC process of generating, then rectifying, and then reinverting power, without the added expense of a transfer switch, and with a smaller energy storage device. The present invention is more efficient, more flexible, less expensive, smaller and lighter.

The engine controller 414 may be coupled to the inverter 406 or inverter controller 416 via an analog or digital link. For example, the link may be a serial link, such as a Controller Area Network (CAN). The engine controller 414 may be used to manage the start up, cool down, and fault detection of the engine 402. Further, the engine controller 414 may be used to operate the engine 402 at a specified speed, torque, or power level. The specified operation point may be chosen to maximize efficiency or minimize reaction time depending on the application. The run, stop or operation point value of the engine controller 414 may be sent from the inverter 406 or the inverter controller 416 to the engine controller 414. Alternatively, the engine controller 414 may determine the optimum speed or torque autonomously.

It should be understood that, while the present invention has been described in detail herein, the invention can be embodied otherwise without departing from the principles thereof, and such other embodiments are meant to come within the scope of the present invention as defined in the following claim(s).

1. A distributed generation system, comprising:
an engine coupled to an asynchronous generator, the generator generating a first AC output,
an energy storage device for producing a DC output,
an inverter for converting the DC output of the energy storage device into a second AC output,
an engine controller coupled between the engine and the inverter, the inverter controlling the frequency of the first AC output to match the frequency of a coupled utility grid.

2. The distributed generation system of claim 1, wherein the first AC output is coupled in parallel to the second AC output.

3. The distributed generation system of claim 1, wherein the inverter and the generator operate simultaneously.

4. The distributed generation system of claim 1, wherein the inverter, the generator, and the utility grid operate simultaneously.

5. The distributed generation system of claim 1, wherein the inverter converts the DC output into a three-phase AC output.

6. The distributed generation system of claim 1, wherein the inverter comprises a PWM inverter.

7. The distributed generation system of claim 6, further comprising a filter to smooth AC output.

8. The distributed generation system of claim 1, further comprising an inverter controller capable of monitoring a coupled load.

9. The distributed generation system of claim 8, wherein the inverter controller performs peak shaving.

10. The distributed generation system of claim 8, wherein the inverter controller performs net-metering.

11. The distributed generation system of claim 8, wherein the inverter controller senses the zero cross of the coupled utility grid.

12. The distributed generation system of claim 1, wherein the energy storage device is an ultracapacitor.

13. The distributed generation system of claim 1, wherein the energy storage device is a battery.

14. The distributed generation system of claim 1, wherein the inverter further controls the amplitude of the first AC output.

15. The distributed generation system of claim 1, wherein the engine controller controls at least one of the speed, torque or power of the engine.
